(19) United States
(12) Patent Application Publication
(10) Pub. No.: US 2013/0066703 A1
(43) Pub. Date: Mar. 14, 2013

(54) SYSTEMS AND METHODS WHEREIN A CENTRAL HUB SELECTS OFFERS BASED ON PRODUCT INFORMATION FROM ENTERPRISE DATA MANAGEMENT SYSTEMS

(71) Applicants: Elad Razy, Haifa (IL); Saleem Boshnak, Haifa (IL); Ronen Cohen, Gasher Haziv (IL); Oren Haze, Kfar-Saba (IL)

(72) Inventors: Elad Razy, Haifa (IL); Saleem Boshnak, Haifa (IL); Ronen Cohen, Gasher Haziv (IL); Oren Haze, Kfar-Saba (IL)

(21) Appl. No.: 13/227,594

(22) Filed: Sep. 8, 2011

(51) Int. Cl. G06Q 30/00

(52) U.S. Cl. 705/14.39

(57) ABSTRACT

According to some embodiments, a central hub may establish a preference profile associated with a user, and the preference profile may include, for example at least some information not provided by the user. Catalogue data may then be exchanged between the central hub and a first and second retailer that store product information in association with a enterprise data management systems. The central hub may receive user information associated with the user (including location information) from a remote user device. Based on (i) the user information, (ii) the catalogue data from the first and second retailers, and (iii) a set of business rules established at the central hub, an offer may be selected and information about the selected offer may be transmitted to the remote user device.

### FIELD

Some embodiments relate to systems and methods associated with offers that may be provided to users. More specifically, some embodiments are directed to systems and methods wherein a central hub selects offers based on product information from enterprise data management systems.

### BACKGROUND

When a potential customer considers purchasing a product or service, he or she may consider several factors and options associated with different products and/or retailers. This can result in a complicated comparison process because different retailers might set different prices for similar commodities, products, items on a “shopping list,” etc. In addition, different users may have different personal preferences with regard to their purchasing decisions. For example, one user might be primarily concerned about a level of service (e.g., a service speed or level of hospitality) while another is more interested in finding organic or environmentally friendly products. Still other users might be more interested in price, an amount of currently available parking, inventory availability, etc.

Moreover, multiple retailers may be interested in providing messages, such as offers, to users. However, product information may be stored and maintained by different retailers in a variety of formats. As a result, it can be difficult for potential customers to accurately compare product prices and features between various retailers.

Accordingly, a method and mechanism to efficiently, accurately, and automatically select appropriate offers for users may be provided in accordance with some embodiments described herein.

### BRIEF DESCRIPTION OF THE DRAWINGS

FIG. 1 is a block diagram of a system according to some embodiments.

FIG. 2 is a flow diagram of a process according to one embodiment that might be implemented.

FIG. 3 illustrates a selected offer display in accordance with some embodiments.

FIG. 4 illustrates a user profile display in accordance with some embodiments.

FIG. 5 is more detailed diagram of a system in accordance with some embodiments

FIG. 6 illustrates a display that might be provided to a user according to some embodiments.

FIG. 7 is a block diagram of a central hub according to some embodiments.

FIG. 8 is a portion of a user profile database in accordance with some embodiments.

FIG. 9 is a portion of a retailer catalogue database in accordance with some embodiments.

FIG. 10 is a portion of a tabular offer database in accordance with some embodiments.

FIG. 11 is a flow diagram of a process according to one embodiment that might be implemented.

FIG. 12 is an illustration of a user display in accordance with some embodiments.

### DETAILED DESCRIPTION

A potential customer who is considering a purchase of a product or service may consider several factors and options associated with different products and/or retailers. Note that different users may have different personal preferences with regard to purchasing decisions. For example, one user might be primarily concerned about a level of service while another is more interested in price. Further note that retailers may be interested in providing messages, such as offers, to potential customers, but product information may be stored and maintained by different retailers in a variety of formats. As a result, it can be difficult for potential customers to accurately compare product prices and features between various retailers.

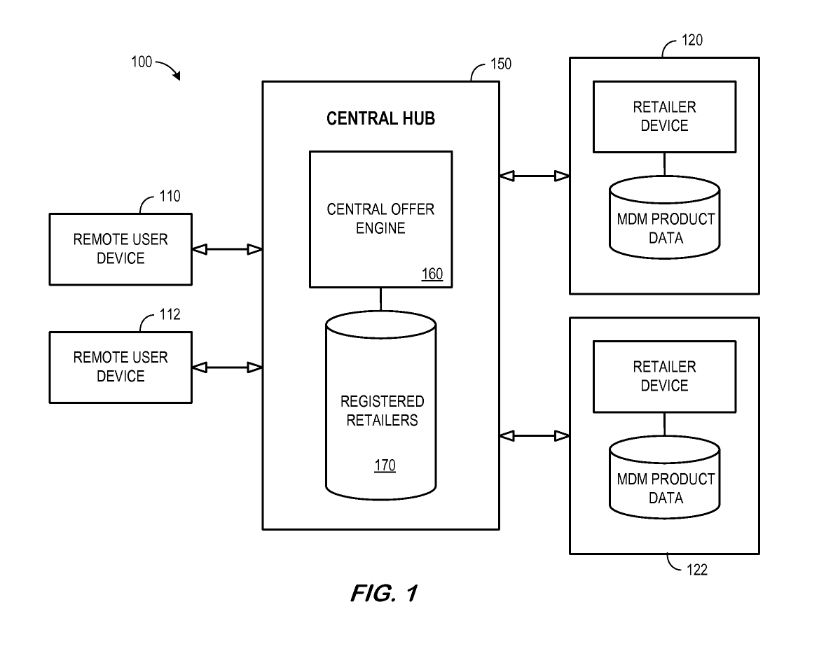

Accordingly, a method and mechanism to efficiently, accurately, and automatically select appropriate offers for a user may be provided in accordance with some embodiments described herein. For example, FIG. 1 is a block diagram of a system 100 that includes user devices 110, 112 that may receive offers associated with retailers 120, 122. The system 100 includes a central hub 150 that may establish connections with potential customers via the remote user devices 110, 120. The central hub 150 and/or remote user devices 110, 112 may comprise, for example, Personal Computers (PCs), laptop computers, servers, wireless smart phones, game systems, or another other appropriate device. According to some embodiments, the remote user devices 110, 112 include a location aware element, such as a Global Positioning System (“GPS”) element.

The central hub 150 may receive information about products from the retailers 120, 122. For example, each retailer 120, 122 may maintain a retailer device that can access information from an enterprise data management system, such as Master Data Management (“MDM”) product data. As used herein, MDM product data may be associated with processes and/or tools that consistently define and manage data for an organization. Some of the MDM processes performed by the retailers 120, 122 may include, for example, collecting, aggregating, matching, consolidating, quality-assuring, persisting, and/or distributing product data throughout an organization to ensure consistency and control in the ongoing maintenance and use of the product data.

The central hub 150 may receive catalogue data from the retailer devices 120, 122, and a central offer engine 160 may then access product data associated with registered retailers 170 in order to select appropriate offers to transmit to the remote user devices 110, 112 (e.g., as a notification or alert to the user). According to some embodiments, the remote user devices 110, 112 and/or services described herein may be provided free to users (e.g., the costs might be subsidized by the retailers, a party associated with the central hub 150, advertising, etc). Moreover, any of the embodiments described herein might be provided as an “on-demand” service.

Note that FIG. 1 represents a logical architecture according to some embodiments, and actual implementations may include more or different components arranged in other manners. Moreover, each system described herein may be implemented by any number of devices in communication via any number of other public and/or private networks. Two or more of devices may be located remote from one another and may communicate with one another via any known manner of network(s) and/or a dedicated connection. Further, each device may comprise any number of hardware and/or software elements suitable to provide the functions described herein as well as any other functions. Other topologies may be used in conjunction with other embodiments.

Any of the devices illustrated in FIG. 1, including the central hub 150 and remote user devices 110, 112, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

All systems and processes discussed herein may be embodied in program code stored on one or more non-transitory computer-readable media. Such media may include, for example, a floppy disk, a CD-ROM, a DVD-ROM, magnetic tape, solid state Random Access Memory (“RAM”) or Read Only Memory (“ROM”) storage units. Embodiments are therefore not limited to any specific combination of hardware and software.

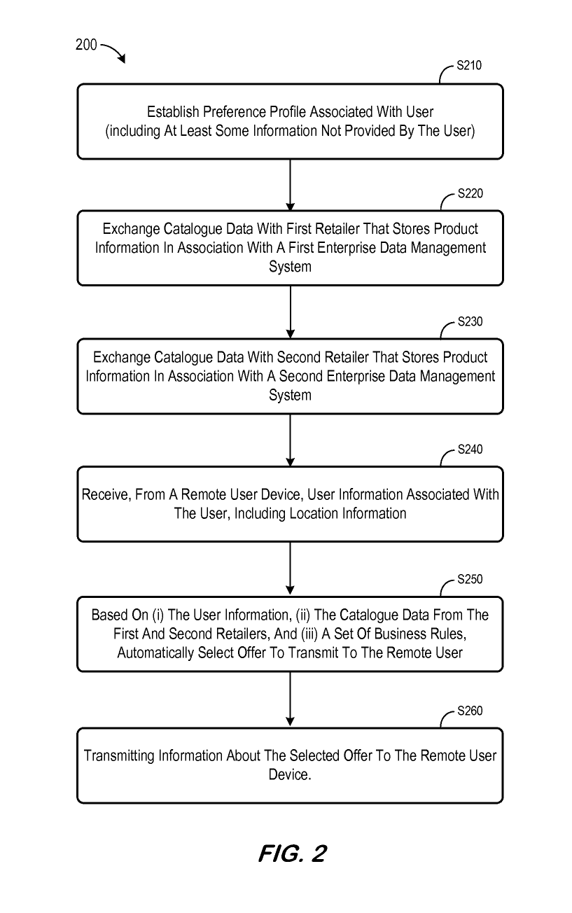

FIG. 2 is a flow diagram of a process 200 that might be associated with the central hub 150 of FIG. 1 according to some embodiments. Note that all processes described herein may be executed by any combination of hardware and/or software. The processes may be embodied in program code stored on a tangible medium and executable by a computer to provide the functions described herein. Further note that the flow charts described herein do not imply a fixed order to the steps, and embodiments of the present invention may be practiced in any order that is practicable.

At S210, a preference profile associated with a user may be established. For example, a central hub may create and/or update preference profiles associated with a number of different users. The preference profile may include information received from a user, such as his or her name, user device identifier, age, and/or gender. According to some embodiments, a user may establish a set of preferences with a central hub. For example, he or she might indicate one or more distance preferences (e.g., stores located with five miles are preferred when he or she is driving), a product cost preference, a product type preference (e.g., his or her favorite brand), a retailer preference (e.g., indicating that he or she preferred small local retails as compared to national ones), and/or an offer channel preference (e.g., please forward offers to a particular smartphone).

According to some embodiments, the user may provide a shopping list (e.g., of food items) to the central hub. The shopping list might be, for example, a list of items that the user purchases on a periodic basis (e.g., he or she purchases one gallon of milk each week). Other examples of information that might be provided by a user include a current destination (e.g., he or she might indicate that they are driving home from work) and environmental information (e.g., that he or she prefers to purchase items that use recycled materials and/or are energy efficient whenever possible).

According to some embodiments, the preference profile includes at least some information not directly provided by the user. For example, a user's past purchases or transaction history may be analyzed to automatically generate a list of items that may be of interest to that user in the future. As another example, the central hub might access social network information about a user, including his or her relationship status, interest information, friend information, and/or family information

At S220, catalogue data may be exchanged between the central hub and a first retailer that stores product information in association with a first enterprise data management system. Similarly, At 230, catalogue data may be exchanged between the central hub and a second retailer that stores product information in association with a second enterprise data management system. Either of the enterprise data management systems may be associated with, for example, an MDM system, an enterprise resource planning system, a business information warehouse, and/or a high volume database. The catalogue data might include, for example, a retailer identifier, a product identifier, a product cost, a product description, offer information, environmental information, location information, transportation information, and/or inventory information (e.g., the retailer has seven televisions currently in stock).

At S240, user information associated with the user, including location information, may be received at the central hub from a remote user device. For example, a user's smartphone might transmit the users current location to the central hub. As other examples, the user information might include a user direction, a user velocity, a user destination, a user origination, and/or user transportation information (e.g., whether the user is walking, driving, or riding a train). Note that the remote user device might comprise a PC, a mobile computer, a smartphone, a vehicle computer, and/or a game system.

At S250, an offer may be “automatically” selected for the user based on (i) the user information, (ii) the catalogue data from the first and second retailers, and (iii) a set of business rules established at the central hub. As used herein, the term “automated” may refer to, for example, actions that can be performed with little or no human intervention. Note that the set of business rules might include a weighted analysis, a neural network, and/or a multi-variable analysis. The offer selected for the user might be associated with, for example, a coupon, a discount, a service, a loyalty program, and/or inventory information.

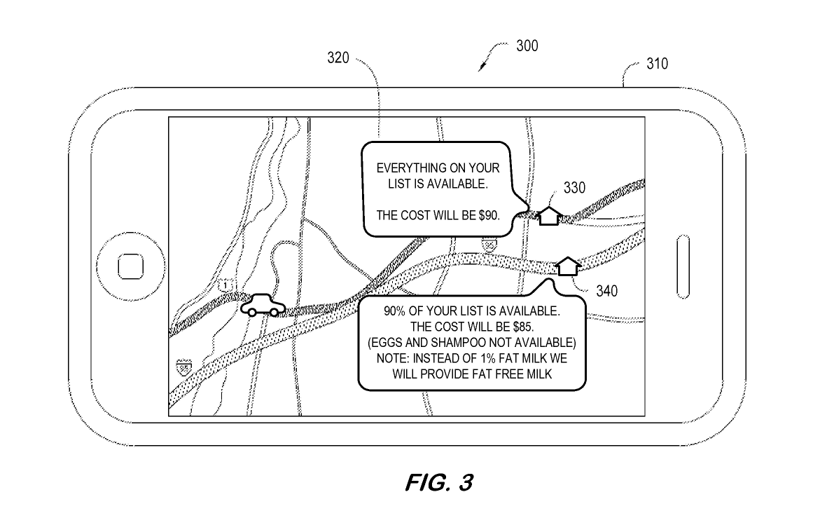

At S260, information about the selected offer may be transmitted to the remote user device. The information about the selected offer transmitted to the remote user device might include, for example, text information, audio information, image information, and/or video information. FIG. 3 illustrates a system 300 including a smartphone 310 with a display screen 320. The display screen 320 displays a map including two retailer location icons 330, 340. Moreover, information about an offer selected by a central hub is displayed in connection with one of those retailer location icons 340 (e.g., indicating that certain items on his or her shopping list are available at a discount) in accordance with some embodiments.

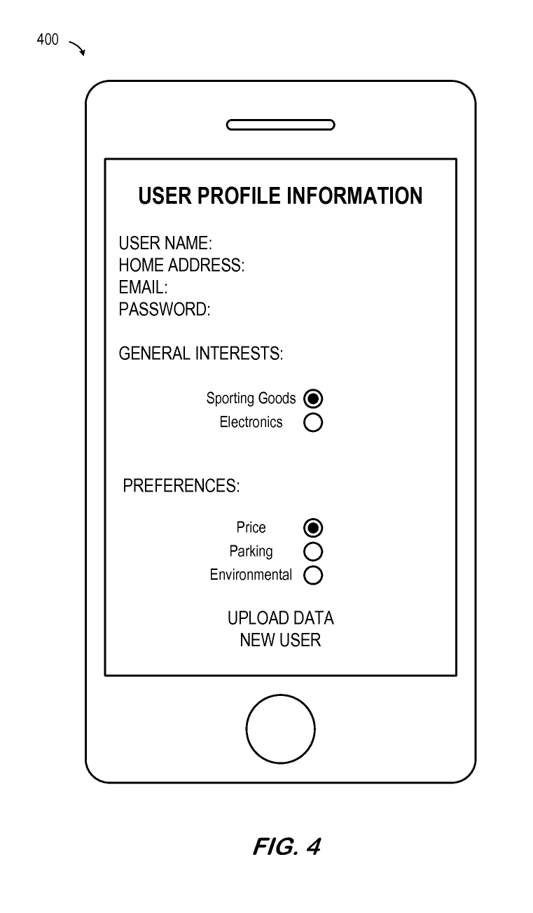

In addition to transmitting offers to users, a central hub may receive information from users via a remote user device. For example, FIG. 4 illustrates a user profile display 400 in accordance with some embodiments. The user profile display 400 may, for example, let a user enter his or her name, home address, email, and/or password information. The user might also select his or her interests and/or preferences (e.g., regarding products and/or retailers).

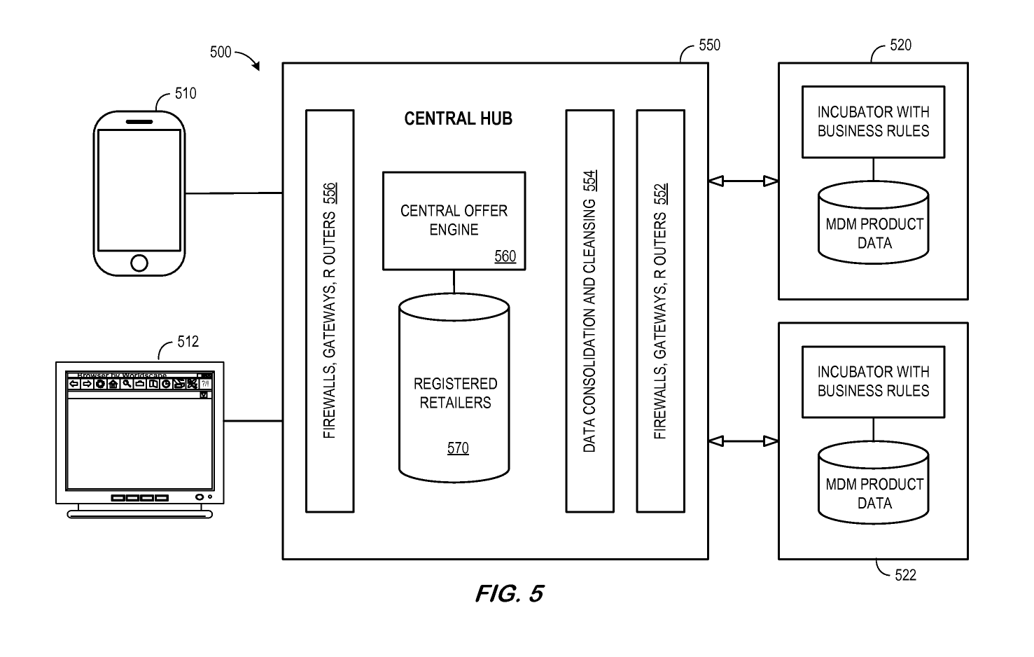

FIG. 5 is more detailed diagram of a system 500 in accordance with some embodiments. As before, the system 500 includes user devices 510, 512 that may receive offers associated with retailers 520, 522. The system 500 includes a central hub 550 that may establish connections with potential customers via the remote user devices 510, 520 through a series of firewalls, gateways, and routers 556. The central hub 550 and/or remote user devices 510, 512 may comprise, for example, PCs, laptop computers, servers, wireless smart phones, game systems, or another other appropriate device. According to some embodiments, the remote user devices 510, 512 include a location aware element, such as a GPS element.

The central hub 550 may receive information about products from the retailers 520, 522. For example, each retailer 520, 522 may maintain a retailer device that can access information from an enterprise data management system, such as MDM product data. The central hub 550 may receive catalogue data from the retailer devices 520, 522 through another series for firewalls, gateways, and routers 552. According to some embodiments, data consolidation and/or cleansing processes 554 may be performed on the received catalogue data (e.g., to ensure consistency between retailers 520, 522).

According to some embodiments, the central hub 550 is further able to access “social network” data. A social network may include entities, such as potential customers, who may be “linked” to other entities who, in turn, may be linked to still other entities. Social network entities may be “linked,” for example, if they are friends or contacts on a social network web site. Such social networks are an increasing popular way for people to communicate and exchange information with friends (and friends of friends, etc.). For example, an entity might post or otherwise display information about his or her current activities or interests to be automatically distributed to other entities in the social network (e.g., in accordance with the pre-established links). For exemplary purposes, such sites/networks may include ebay.com, Facebook.com, LinkedIn.com, AngiesList.com, Twitter.com, Blogger.com, MySpace.com, Friendster.com, and other similar sites. The social network data may be stored at a server or server farm remote from the central hub 550.

The collected social network information might include, for example, an age, a gender, a relationship status (e.g., whether the potential customer is married or single), interest information (e.g., his or her hobbies or favorite web sites), friend information (e.g., how many friends he or she has or what activities are of interest to those friends), family information (e.g., how many children he or she has), a level on online activity (e.g., whether or not he or she post something everyday), and/or a geographic location (e.g., a ZIP code, hometown, or latitude and longitude information).

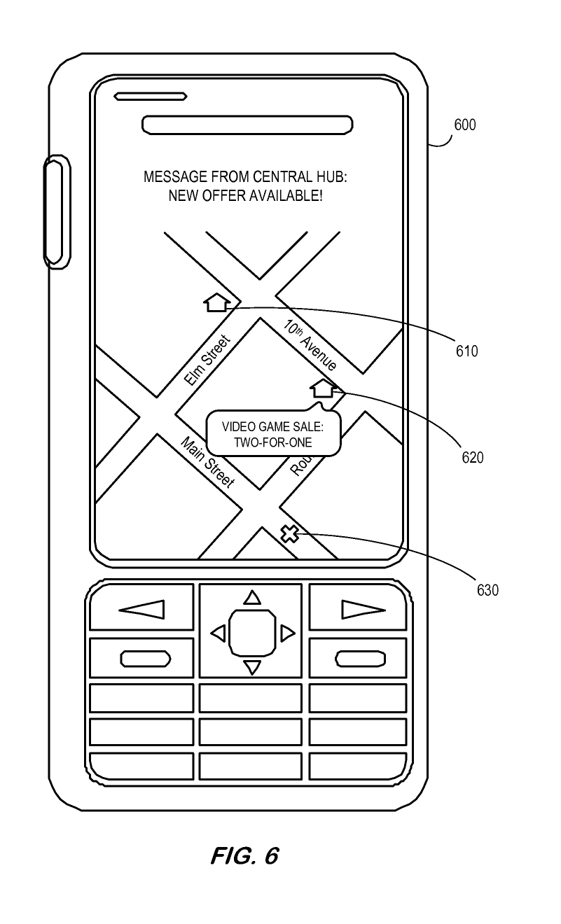

A central offer engine 560 may then access product data associated with registered retailers 570, and use that data along with the potential customer's social network information to select appropriate offers to transmit to the remote user devices 510, 512. For example, FIG. 6 illustrates a wireless telephone 600 display that might be provided to a user according to some embodiments. In this example, retailer location icons 610, 620 are displayed along with a current user location 630. One or more selected offers may be displayed in connection with the retailer location icons 610, 620 (e.g., based on the types of products the user's friends have purchased in that area). According to some embodiments, a user might select a retailer icon 610, 620 to learn more about a particular offer.

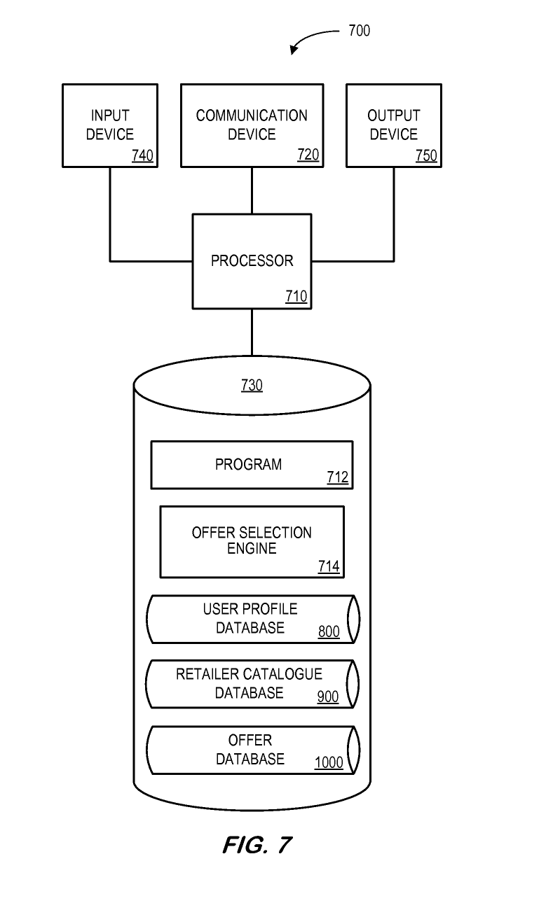

FIG. 7 is a block diagram overview of a central hub 700 according to some embodiments. The central hub 700 may be, for example, associated with the systems 100, 500 described with respect to FIGS. 1 and 5, respectively. The central hub 700 comprises a processor 710, such as one or more commercially available Central Processing Units (CPUs) in the form of one-chip microprocessors, coupled to a communication device 720 configured to communicate via a communication network (not shown in FIG. 7). The communication device 720 may be used to communicate, for example, with one or more remote user devices and/or retailers. The central hub 700 further includes an input device 740 (e.g., a mouse and/or keyboard to enter information about offer selection rules) and an output device 750 (e.g., a computer monitor to display aggregated information about users, retailers, products, and/or offers).

The processor 710 communicates with a storage device 730. The storage device 730 may comprise any appropriate information storage device, including combinations of magnetic storage devices (e.g., a hard disk drive), optical storage devices, and/or semiconductor memory devices. The storage device 730 stores a program 712 and/or offer selection engine 714 for controlling the processor 710. The processor 710 performs instructions of the programs 712, 714, and thereby operates in accordance with any of the embodiments described herein. For example, the processor 710 may establish a preference profile associated with a user (including at least some information not provided by the user). The processor 710 may also exchange catalogue data between with a retailers that store product information in association with enterprise data management systems. The processor 710 may also receive, from a remote user device, user information associated with the user, including location information. Based on (i) the user information, (ii) the catalogue data from the first and second retailers, and (iii) a set of business rules, the processor 710 and/or offer selection engine 712 may automatically select an offer to transmit to the remote user. The processor 710 may also arrange to transmit information about the selected offer to the remote user device.

The programs 712, 714 may be stored in a compressed, uncompiled and/or encrypted format. The programs 712, 714 may furthermore include other program elements, such as an operating system, a database management system, and/or device drivers used by the processor 710 to interface with peripheral devices.

As used herein, information may be “received” by or “transmitted” to, for example: (i) the central hub 700 from another device; or (ii) a software application or module within the central hub 700 from another software application, module, or any other source.

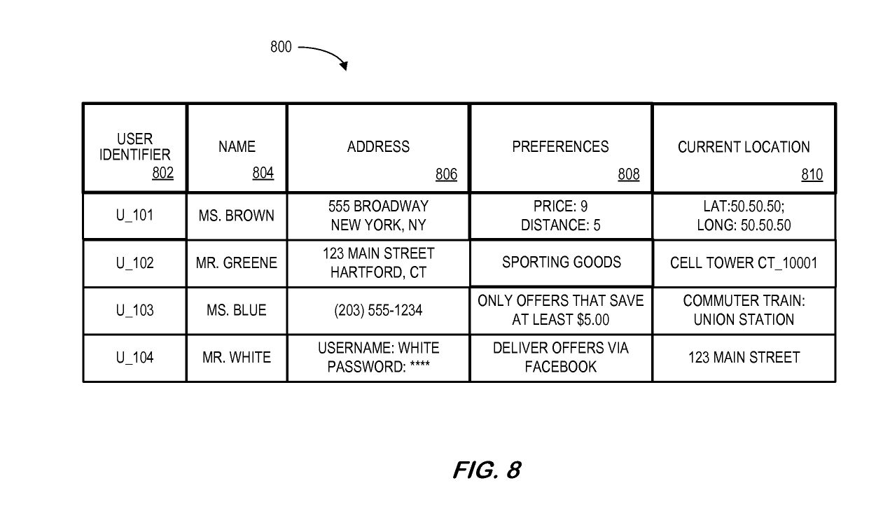

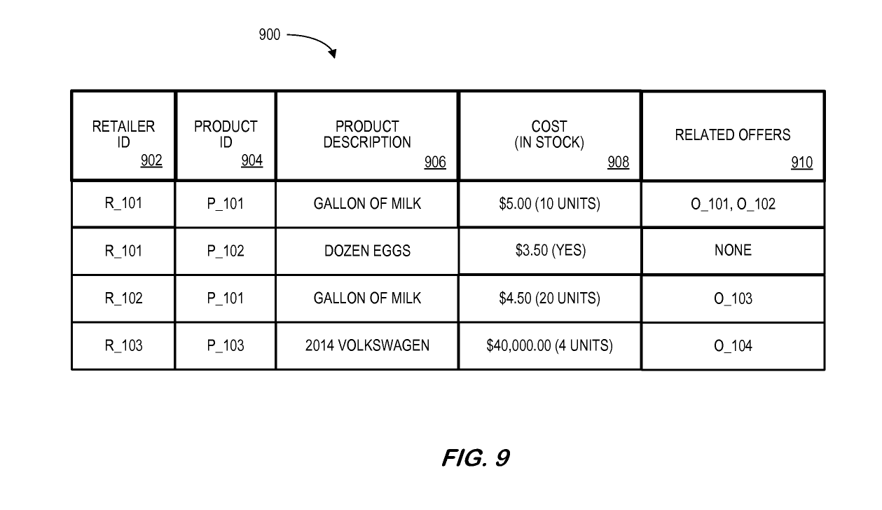

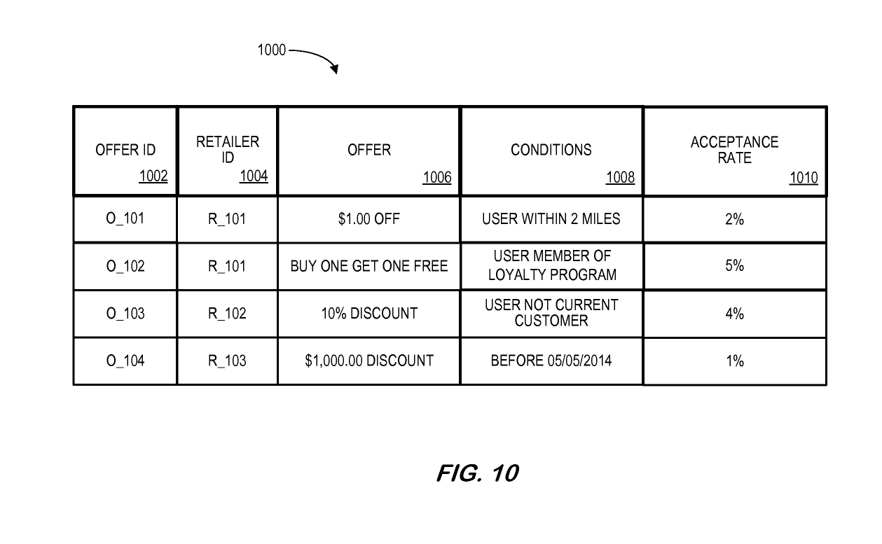

In some embodiments (such as shown in FIG. 7), the storage device 730 stores a user profile database 800 (described with respect to FIG. 8), a retailer catalogue database 900 (described with respect to FIG. 9), and an offer database 1000 (described with respect to FIG. 10). Examples of databases that may be used in connection with the central hub 700 will now be described in detail with respect to FIGS. 8 through 10. Note that the databases described herein are examples, and additional and/or different information may be stored therein. Moreover, various databases might be split or combined in accordance with any of the embodiments described herein.

Referring to FIG. 8, a table is shown that represents the user profile database 800 that may be stored at the central hub 700 according to some embodiments. The table may include, for example, entries identifying users who may be potential customers. The table may also define fields 802, 804, 806, 808, 810 for each of the entries. The fields 802, 804, 806, 808, 810 may, according to some embodiments, specify: a user identifier 802, a name 804, an address 806, preferences 808, and a current location 810. The information in the user profile database 800 may be created and updated, for example, based on data received from a user and/or user device.

The user identifier 802 may be, for example, a unique alphanumeric code identifying a user who may be a potential customer. The name 804 might represent the potential customer's name and the address 806 might represent his or her postal address, phone number, email address, account username and password, or any other information that might be used to communicate with the user. The preferences 808 stored in the user profile database 800 might indicate, for example, a relative or weighted importance of various product features (e.g., price and distance from his or her current location), his or her interests, what types of offers should be provided, and/or a channel through which offers should preferably be distributed (e.g., via a social networking site). The current location 810 might indicate where the user is presently located, his or her direction of movement, etc. Note that other information may be stored in the user profile database 800 in addition to that illustrated in FIG. 8. For example, an age, a gender, interest information, friend information, family information, and/or a level on online activity might also be stored in the user profile database 800.

Referring to FIG. 9, a table is shown that represents the retailer catalogue database 900 that may be stored at the sales engine 700 according to some embodiments. The table may include, for example, entries identifying retailer catalogue data associated with potential customers. The table may also define fields 902, 904, 906, 908, 910 for each of the entries. The fields 902, 904, 906, 908, 910 may, according to some embodiments, specify: a retailer catalogue identifier 902, a product identifier 904, a product description 906, a cost 908, and related offers 910. The information in the retailer catalogue database 900 may be created and updated, for example, based on data received from a retailer catalogue system or application.

The retailer catalogue identifier 902 may be, for example, a unique alphanumeric code identifying the retailer that supplied the catalogue data. The product identifier 904 may be associated with, for example, a particular product, model, and/or manufacturer. For example, retailer “R_{—}101” has supplied information about two products: “P_{—}101” and “P_{—}102.” The product description 906 might describe the product and might include, for example, text, image, audio, and/or video information. The cost 908 of the product might also be stored in the retailer catalogue database 900 along with an indication of whether or not the product is currently in stock (or how many units are currently in stock) at that retailer. According to some embodiments, the retailer catalogue 900 may also store one or more related offers 910 that might be transmitted to remote user devices. Note that other information may be stored in the retailer catalogue database 900 in addition to that illustrated in FIG. 9. For example, transaction identifiers, detailed purchased histories, and/or previously accepted or rejected offers could also be stored in the retailer catalogue database 900.

Referring to FIG. 10, a table is shown that represents the offer database 1000 that may be stored at the central hub 700 according to some embodiments. The table may include, for example, entries identifying offer data associated with potential customers. The table may also define fields 1002, 1004, 1006, 1008, 1010 for each of the entries. The fields 1002, 1004, 1006, 1008, 1010 may, according to some embodiments, specify: an offer identifier 1002, a retailer identifier 1004, an offer 1006, conditions 1008, and an acceptance rate 1010. The information in the offer database 1000 may be created and updated, for example, based on data received from a retailer and/or from a potential customer.

The offer identifier 1002 may be, for example, a unique alphanumeric code identifying an offer that has been (or may be) provided to a potential customer and may or may not be associated with the related offers 910 stored in the retailer catalogue database 9900. The retailer 1004 might represent the retailer who is providing the offer (and may or may not be based on or identical to the retailer identifier 802 stored in the retailer catalogue database 900) while the offer 1006 might describe the type of offer and/or the terms of the offer in detail. According to some embodiments, the offer database 1000 may also store one or more product identifiers in connection with an offer. The conditions 1008 may define one or more rules that need to be satisfied before the offer can be provided to a user. The acceptance rate 1010 might be a dynamically updated percentage indicating how many users are accepting the offer. Note that other information may be stored in the offer database 1000 in addition to that illustrated in FIG. 10. For example, an offer benefit (e.g., a fee paid to a central hub), image information, etc. might also be stored in the offer database 1000.

Thus, some embodiments may provide a method and mechanism to efficiently, accurately, and automatically select appropriate offers for users. Some embodiments may provide a multi-channel system and/or mechanism for personalized recommendations, messages, and/or alerts in connection with offers. Moreover, comparisons and/or results of such comparisons may be automatically performed and/or displayed to users based on their physical location, personal preferences etc.

In this way, some embodiments may provide a comprehensive solution and/or system that generates personalized recommendations to users, via different channels and technologies (e.g., mobile phones, web and/or PC based applications) from retailers (e.g., supermarkets, stationary stores, sports equipment retailers, furniture display showrooms, electronics retailers, and/or food merchants) including messages and/or alerts associated with sales opportunities. Note that the selected offers may, take into consideration the different and/or constantly adjusting routes the user is taking, and thus using one or more retailers to perform the comparison as appropriate based on location.

Some embodiments of the present invention may also be helpful to users who are traveling. For example, when a user is away from home his or her unfamiliarity with the newly available retailers, potentially different languages, and currency conversion factors might make selecting an appropriate retailer more difficult. By performing comparisons and selections for a user, a central hub may simplify his or her choices.

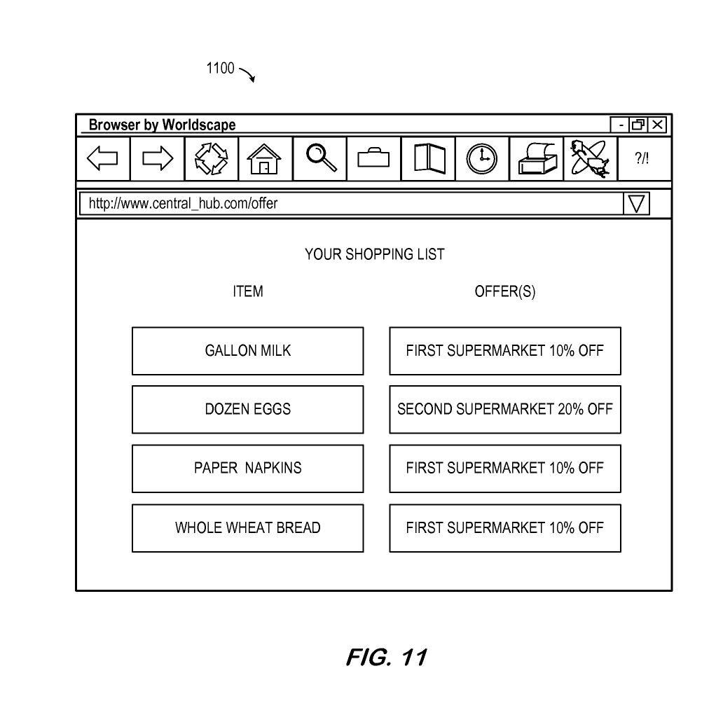

Moreover, by enhancing mobile and/or web platforms as described herein, customer loyalty and/or sales might increase for a retailer, and improved communications and interactions with potential and actual customers may be provided (e.g., via offer notifications, messaging, alerts etc.). FIG. 11 is an illustration of a user display 1100 in accordance with some embodiments. Such a display 1100 may, for example, be used by retailers to communicate offers to remote users in reaction to items on his or her current shopping list. According to some embodiments, recommendations and/or offers may be suited to the specific user profile, and additional or interchangeable products might be suggested to a user according his or her preferences (e.g., if the user prefers organic products or inexpensive products).

Some embodiments may identify and improve monitoring capabilities associated with a user's preferences. For example, a system may learn the user's stated, known preferences and predict his or her unstated, unknown preferences in order to better meet the customer's needs.

In addition, some embodiments may increase profitability and/or efficiency of a retailer. For example, a retailer may use offer to balance store loads by shifting customers between different branches or encouraging customers to buy during periods of low demand (e.g., late at night). Moreover, the central hub may provide a platform for the relatively quick and dynamic adoption of an organization's marketing strategy and campaigns.

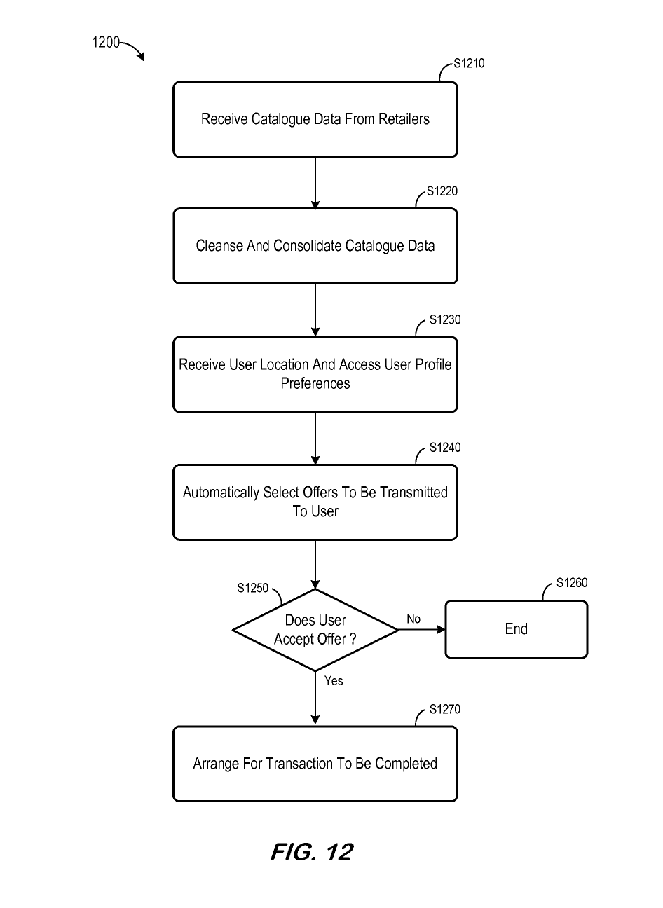

For example, FIG. 12 is a flow diagram of a process 1200 according to one embodiment that might be implemented. At S1210, catalogue data is received from retailers. For example, a retailer introducing a new product might provide information about that product to a central hub along with special offers that may be provided to potential customers.

At S1220, the central hub may cleanse and/or consolidate the catalogue data. For example, information may be transformed such that pricing values between retailers can be compared on an appropriate basis. At S1230, user location data is received and the user's profile preferences are accessed. Based on that information, offers to be transmitted to the user are automatically selected at S1240. For example, a coupon for the retailer's newly introduced product might transmitted to all user devices who are currently within ten miles of that retailer.

According to some embodiments, it may be determined if the user will accept the offer at S1250. For example, central hub might receive from the remote user device an indication of acceptance of the offer (e.g., when user activate an icon on his or her smartphone). If the user does not accept the offer at S1250, the process ends at S1260 (or other offers might be selected for the user instead).

If the user does accept the offer at S1250, the central hub may arrange for the transaction to be completed at S1270. For example, the central hub might place a charge on the user's credit card and/or transmit a message to the retailer to facilitate a completion of the transaction between the user the retailer. The user could then stop by the retailer and pick up the newly introduced product.

The following illustrates various additional embodiments and do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although embodiments have been described with respect to particular types of offers, note that embodiments may be associated with other types of offers. For example, banking, restaurant, travel, business-to-business, and other related offers may be processed in accordance with any of the embodiments described herein.

Moreover, while embodiments have been illustrated using particular ways of providing offers, embodiments may be implemented in any other of a number of different ways. For example, some embodiments might be associated with an offer verbally provided by a sales representative (e.g., who establishes a video chat connection via a remote user device).

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A computer-implemented method, comprising:
establishing, at a central hub, a preference profile associated with a user, the preference profile including at least some information not provided by the user;
exchanging catalogue data between the central hub and a first retailer that stores product information in association with a first enterprise data management system;
exchanging catalogue data between the central hub and a second retailer that stores product information in association with a second enterprise data management system;
receiving, at the central hub from a remote user device, user information associated with the user, including location information;
based on (i) the user information, (ii) the catalogue data from the first and second retailers, and (iii) a set of business rules established at the central hub, automatically selecting an offer to transmit to the remote user; and
transmitting information about the selected offer to the remote user device.

2. The method of claim 1, wherein at least one of the enterprise data management systems is associated with: (i) a master data management system, (ii) an enterprise resource planning system, (iii) a business information warehouse, or (iv) a high volume database.

3. The method of claim 1, wherein the preference profile includes at least one of: (i) a user name, (ii) a user device identifier, (iii) a distance preference, (iv) a product cost preference, (v) a product type preference, (vi) a retailer preference, (vii) an offer channel preference, (viii) a shopping list, (ix) a transaction history, (x) a current destination, (xi) an age, (xii) a gender, (xiii) a relationship status, (xiv) interest information, (xv) social network friend information, (xvi) family information, or (xvii) an environmental preference.

4. The method of claim 1, wherein the catalogue data includes at least one of: (i) a retailer identifier, (ii) a product identifier, (iii) a product cost, (iv) a product description, (v) offer information, (vi) environmental information, (vii) location information, (viii) transportation information, or (ix) inventory information.

5. The method of claim 1, wherein the user information includes at least one of: (i) a user location, (ii) a user direction, (iii) a user velocity, (iv) a user destination, (v) a user origination, or (vi) user transportation information.

6. The method of claim 1, wherein the set of business rules includes at least one of: (i) a weighted analysis, (ii) a neural network, or (iii) a multi-variable analysis.

7. The method of claim 1, wherein the selected offer is associated with at least one of: (i) a coupon, (ii) a discount, (iii) a service, (iv) a loyalty program, or (v) inventory information.

8. The method of claim 1, wherein the information about the selected offer transmitted to the remote user device includes at least one of: (i) text information, (ii) audio information, (iii) image information, or (iv) video information.

9. The method of claim 1, wherein the remote user device comprises at least one of: (i) a personal computer, (ii) a mobile computer, (iii) a smart phone, or (iv) a game system.

10. The method of claim 1, further comprising:
receiving from the remote user device an indication of acceptance of the offer.

11. The method of claim 10, further comprising:
facilitating a completion of the transaction between the user and one of the first or second retailers.

12. A non-transitory, computer-readable medium storing program code executable by a computer to:
establish, at a central hub, a preference profile associated with a user, the preference profile including at least some information not provided by the user;
exchange catalogue data between the central hub and a first retailer that stores product information in association with a first enterprise data management system;
exchange catalogue data between the central hub and a second retailer that stores product information in association with a second enterprise data management system;
receive, at the central hub from a remote user device, user information associated with the user, including location information;
based on (i) the user information, (ii) catalogue data from the first and second retailers, and (iii) a set of business rules established at the central hub, automatically select by an offer engine an offer to transmit to the remote user; and
transmit information about the selected offer to the remote user device.

13. The medium of claim 12, wherein at least one of the enterprise data management systems is associated with: (i) a master data management system, (ii) an enterprise resource planning system, (iii) a business information warehouse, or (iv) a high volume database.

14. The medium of claim 12, wherein the preference profile includes at least one of: (i) a user name, (ii) a user device identifier, (iii) a distance preference, (iv) a product cost preference, (v) a product type preference, (vi) a retailer preference, (vii) an offer channel preference, (viii) a shopping list, (ix) a transaction history, (x) a current destination, (xi) an age, (xii) a gender, (xiii) a relationship status, (xiv) interest information, (xv) social network friend information, (xvi) family information, or (xvii) an environmental preference.

15. The medium of claim 12, wherein the catalogue data includes at least one of: (i) a retailer identifier, (ii) a product identifier, (iii) a product cost, (iv) a product description, (v) offer information, (vi) environmental information, (vii) location information, (viii) transportation information, or (ix) inventory information.

16. The medium of claim 12, wherein the user information includes at least one of: (i) a user location, (ii) a user direction, (iii) a user velocity, (iv) a user destination, (v) a user origination, or (vi) user transportation information.

17. A central hub, comprising:
a storage device to store a preference profile associated with a user, the preference profile including at least some information not provided by the user;
a first communication device to: (i) exchange catalogue data with a first retailer that stores product information in association with a first enterprise data management system, and (ii) exchange catalogue data with a second retailer that stores product information in association with a second enterprise data management system;
a second communication device to receive, from a remote user device, user information associated with the user, including location information; and
an offer engine to select an offer to transmit to the remote user based on (i) the user information, (ii) catalogue data from the first and second retailers, and (iii) a set of business rules established at the central hub,
wherein information about the selected offer is transmitted to the remote user device via the second communication device.

18. The central hub of claim 17, wherein the storage device is further to store at least one of: (i) the catalogue information, or (ii) an offer database.

19. The central hub of claim 18, wherein the set of business rules includes at least one of: (i) a weighted analysis, (ii) a neural network, or (iii) a multi-variable analysis.

20. The central hub of claim 19, wherein the selected offer is associated with at least one of: (i) a coupon, (ii) a discount, (iii) a service, (iv) a loyalty program, or (v) inventory information.

21. The central hub of claim 20, wherein the information about the selected offer transmitted to the remote user device includes at least one of: (i) text information, (ii) audio information, (iii) image information, or (iv) video information.

22. The central hub of claim 21, wherein the remote user device comprises at least one of: (i) a personal computer, (ii) a mobile computer, (iii) a smart phone, or (iv) a game system.
